(19) United States
(12) Patent Application Publication
(10) Pub. No.: US 2026/0004959 A1
(43) Pub. Date: Jan. 1, 2026

(54) MAGNETIC BODY, MAGNET, AND METHOD FOR MANUFACTURING MAGNETIC BODY

(71) Applicants: DENSO CORPORATION, Kariya-city (JP); NICHIA CORPORATION, Anan-shi (JP)

(72) Inventors: Hiroaki KURA, Kariya-city (JP); Yoshiaki HAYASHI, Kariya-city (JP); Kazuki MATSUURA, Anan-shi (JP)

(21) Appl. No.: 19/320,141

(22) Filed: Sep. 5, 2025

Related U.S. Application Data
(63) Continuation of application No. PCT/JP2024/015324, filed on Apr. 17, 2024.

(30) Foreign Application Priority Data
Apr. 21, 2023 (JP) 2023-069919

(51) Int. Cl. H01F 7/02; H01F 41/02

(52) U.S. Cl. CPC H01F 7/02; H01F 41/0266

(57) ABSTRACT

In a magnetic body including magnetic particles that contain an FeNi ordered alloy having an L1₀-type ordered structure, the magnetic particles individually have a flat shape in which a major axis and a minor axis shorter than the major axis intersect each other, and a flat surface along the major axis is larger than a side surface along the minor axis. An easy magnetization axis of the L1₀-type ordered structure lies along the flat surface.

### CROSS REFERENCE TO RELATED APPLICATIONS

The present application is a continuation application of International Patent Application No. PCT/JP2024/015324 filed on Apr. 17, 2024, which designated the U.S. and claims the benefit of priority from Japanese Patent Application No. 2023-069919 filed on Apr. 21, 2023. The entire disclosures of all of the above applications are incorporated herein by reference.

### TECHNICAL FIELD

The present disclosure relates to a magnetic body, a magnet, and a method for manufacturing a magnetic body, each including an FeNi ordered alloy having an L1₀-type ordered structure.

### BACKGROUND

Magnetic materials having an L1₀-type ordered structure, which is a superlattice structure, are expected to be used as magnet materials and magnetic recording materials due to their high magnetic anisotropy. The L1₀-type ordered structure is found in alloys such as FePt, FePd, and AuCu. FeNi superlattices, that is, FeNi ordered alloys with an L1₀-type ordered structure mainly composed of iron and nickel, which are raw materials that are abundant and inexpensive, are attracting attention. Magnetic materials containing such FeNi ordered alloys have higher heat resistance than conventional rare-earth magnetic materials, and therefore can be suitably applied to electrified products such as motors. As such magnetic materials, for example, materials described in Japanese Patent No. 6528865 are known. The magnetic materials described in Japanese Patent No. 6528865 contain L1₀-type FeNi ordered alloy powder having a degree of order of 0.5 or higher as determined by measurement with an X-ray diffraction apparatus.

### SUMMARY

A magnetic body according to an aspect of the present disclosure includes magnetic particles that contain an FeNi ordered alloy having an L1₀-type ordered structure. The magnetic particles may individually have a flat shape in which a major axis and a minor axis shorter than the major axis intersect each other, and a flat surface along the major axis is wider than a side surface along the minor axis. An easy magnetization axis of the L1₀-type ordered structure may lie along the flat surface.

### BRIEF DESCRIPTION OF DRAWINGS

Objects, features and advantages of the present disclosure will become apparent from the following detailed description made with reference to the accompanying drawings. In the drawings:

FIG. 1 is a schematic diagram of a magnet;

FIG. 2 is a schematic diagram of a magnetic body contained in the magnet;

FIG. 3 is a schematic diagram of a magnetic particle;

FIG. 4 is a schematic diagram showing a cross-sectional structure of the magnetic particle;

FIG. 5 is a schematic diagram showing a lattice structure of an L1₀-type FeNi ordered alloy contained in the magnetic particle;

FIG. 6 is a schematic diagram showing a lattice structure of FeNiN, which is a precursor of the L1₀-type FeNi ordered alloy;

FIG. 7 is a flowchart showing an overview of a method for manufacturing magnetic body according to Examples 1 to 3;

FIG. 8 is a flowchart showing an overview of a method for manufacturing a magnetic body according to Comparative Example 1;

FIG. 9 is a table showing a comparative representation of evaluation results of Comparative Example 1 and Examples 1 to 3;

FIG. 10 is an SEM photograph showing a precursor;

FIG. 11 is an SEM photograph showing an enlarged view of region A in FIG. 10;

FIG. 12 is an SEM photograph showing an enlarged view of region B in FIG. 10;

FIG. 13 is a graph showing XRD patterns of Example 3 and Comparative Example 1;

FIG. 14 is a graph showing an enlarged view of region C in FIG. 13;

FIG. 15 is a graph showing hysteresis curves of Example 3 and Comparative Example 1;

FIG. 16 is an SEM photograph of FeNiN particles in Comparative Example 1;

FIG. 17 is an SEM photograph of FeNiN particles in Example 1;

FIG. 18 is an SEM photograph of FeNiN particles in Example 2;

FIG. 19 is an SEM photograph of FeNiN particles in Example 3;

FIG. 20 is a graph showing the relationship between minor axis length and degree of order in Examples 1 to 3 and Comparative Example 1;

FIG. 21 is a graph showing the relationship between major axis length and coercivity in Examples 1 to 3;

FIG. 22 is a TEM photograph of an FeNiN particle in Example 2;

FIG. 23 is a photograph showing an electron diffraction pattern of the FeNiN particle in FIG. 22;

FIG. 24 is a photograph showing a dark-field image corresponding to a diffraction spot indicated by region F in FIG. 23;

FIG. 25 is a photograph showing a dark-field image corresponding to a diffraction spot indicated by region G in FIG. 23;

FIG. 26 is a TEM photograph of an FeNiN particle in Example 3;

FIG. 27 is a photograph showing an electron diffraction pattern of the FeNiN particle in FIG. 26;

FIG. 28 is a flowchart showing an overview of a method for manufacturing a magnetic body according to Comparative Example 2;

FIG. 29 is an SEM photograph of an FeNi particle in Comparative Example 2;

FIG. 30 is a table showing evaluation results of Comparative Example 2 and Example 2;

FIG. 31 is a flowchart showing an overview of a method for manufacturing a magnetic body according to Example 4;

FIG. 32 is a table showing evaluation results of Example 3 and Example 4;

FIG. 33 is a flowchart showing an overview of a method for manufacturing a magnetic body according to Example 5;

FIG. 34 is a table showing evaluation results of Example 3 and Example 5;

FIG. 35 is a TEM photograph showing cross-sectional shapes of the magnetic particles in Example 3; and

FIG. 36 is a TEM photograph showing cross-sectional shapes of the magnetic particles in Example 5.

### DETAILED DESCRIPTION

In magnetic materials or magnetic bodies containing such FeNi ordered alloys, it is desirable to achieve a higher coercivity.

A magnetic body according to a first aspect of the present disclosure includes magnetic particles that contain an FeNi ordered alloy having an L1₀-type ordered structure. The magnetic particles individually have a flat shape in which a major axis and a minor axis shorter than the major axis intersect each other, and a flat surface along the major axis is wider than a side surface along the minor axis. An easy magnetization axis of the L1₀-type ordered structure lies along the flat surface. A magnet according to a second aspect of the present disclosure includes the above-described magnetic body. A manufacturing method of a magnetic body having magnetic particles containing an FeNi ordered alloy having an L1₀-type ordered structure, according to a third aspect of the present disclosure, includes flattening FeNiN particles and performing a denitriding treatment on the FeNiN particles that have been flattened.

### Embodiments

Hereinafter, embodiments of the present disclosure will be described with reference to the drawings. However, the embodiments described below are examples for embodying the technical idea of the present disclosure, and the present disclosure is not limited to the following embodiments. In the present disclosure, the term “step” is used not only as an independent step but also as a step included in other step as long as an intended purpose of the step is achieved even if it cannot be clearly distinguished from the other step. The same applies to the terms “process” and “procedure.”

### (Configuration)

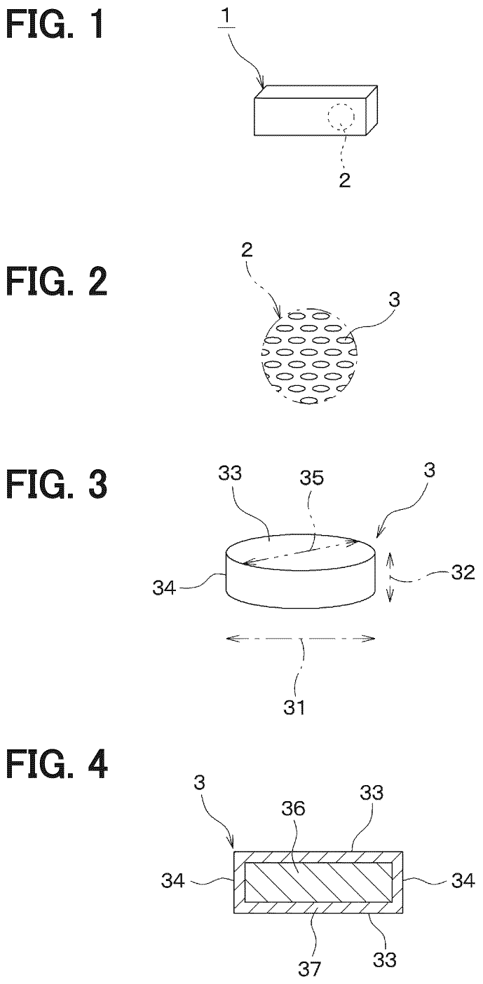

FIGS. 1 to 4 show a magnet 1, a magnetic body 2, and magnetic particles 3. The magnet 1 includes the magnetic body 2. The magnet 1 is formed by shaping the magnetic body 2 into a shape suitable for its intended use.

The magnetic body 2 contains the magnetic particles 3. The magnetic body 2 contains individual magnetic particles 3. The term “individual” refers to a state in which the particles are primary particles that are neither agglomerated nor adhered to each other, and exist independently without being supported by a substrate or other support. That is, the magnetic body 2 may be the magnetic particles 3 themselves in their individual form, a powder composed of an aggregate of such individual magnetic particles 3, a granulated form of such powder, or a molded body of such powder.

As shown in FIG. 3, the magnetic particle 3 is in an individual state and has two flat surfaces 33 that are spaced apart from each other, and an annular side surface 34 that is positioned between the two flat surfaces 33 and connects the two flat surfaces 33. The side surface 34 has a smaller area than the flat surfaces 33. A major axis 31 extends along the flat surfaces 33, and a minor axis 32 extends along the side surface 34. The major axis 31 and the minor axis 32 intersect each other. The minor axis 32 lies in a direction in which the two flat surfaces 33 are arranged. A major axis length, which is a length of the major axis 31 of the magnetic particle 3, is longer than a minor axis length, which is a length of the minor axis 32. In this way, the magnetic particles 3 individually have a flat shape. In the magnetic particle 3, an easy magnetization axis 35 lies along the flat surfaces 33. It should be noted that the major axis length refers to the longest dimension in the direction along the flat surfaces 33. The minor axis length refers to the longest dimension in the direction along the side surface 34 and intersecting the major axis 31.

As shown in FIG. 4, the magnetic particle 3 of the present embodiment includes an alloy particle 36 and a coating layer 37.

The alloy particle 36 contains an FeNi ordered alloy having an L1₀-type ordered structure. In addition to Fe and Ni, the alloy particle 36 may contain additives such as sulfur and unavoidable impurities. The alloy particle 36 forms the shape of the magnetic particle 3 and imparts magnetic properties to the magnetic particle 3.

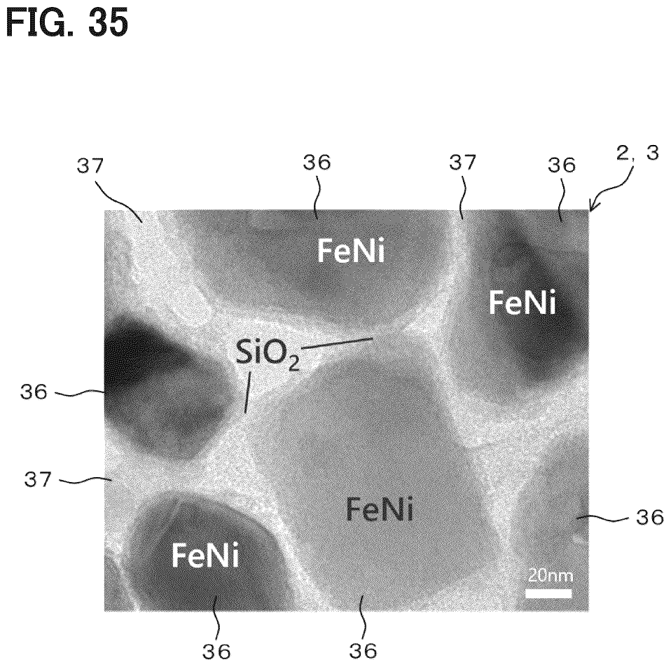

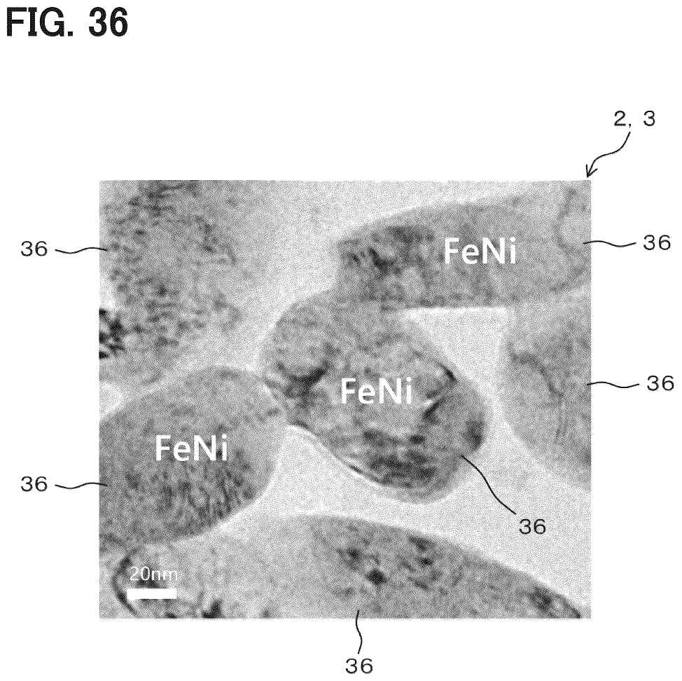

The coating layer 37 covers a surface of the alloy particle 36. For example, as shown in FIG. 35 and FIG. 36, a thickness of the coating layer 37 is expected to be uniform over the entire surface of the alloy particle 36. The coating layer 37 forms both the flat surfaces 33 and the side surface 34 of the magnetic particle 3 in the present embodiment, and a shape of the coating layer 37 is determined by the alloy particle 36. A shape of the flat surfaces 33 is determined by main surfaces of the alloy particle 36, and a shape of the side surface 34 is determined by a peripheral surface of the alloy particle 36. Therefore, the major axis 31 extends along the main surfaces, while the minor axis 32 intersects the major axis 31 and extends along the peripheral surface. The easy magnetization axis 35 lies along the main surfaces. It should be noted that the magnetic particle 3 may not necessarily have the coating layer 37. When the magnetic particle 3 does not have the coating layer 37, the main surfaces of the alloy particle 36 correspond to the flat surfaces 33, and the peripheral surface of the alloy particle 36 corresponds to the side surface 34.

The coating layer 37 serves to interrupt a magnetic coupling, namely, an exchange interaction, between a plurality of magnetic particles 3 (in this case, alloy particles 36) that are adjacent and located in close proximity within the magnetic body 2. Therefore, the coating layer 37 may also be referred to as a “magnetic isolation layer” or a “magnetic isolation coating layer.”

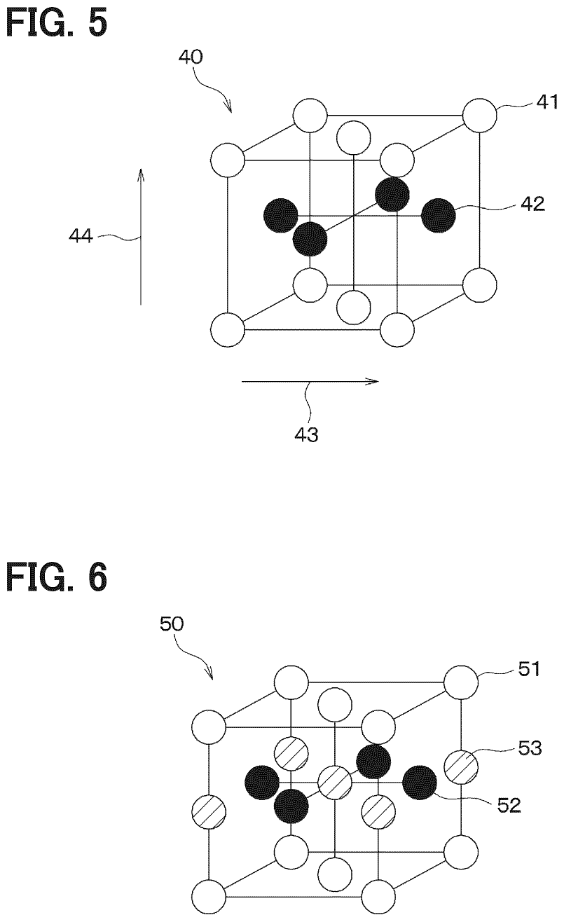

As described above, the alloy particle 36 contains an FeNi ordered alloy having an L1₀-type ordered structure. A unit cell of the FeNi ordered alloy having the L1₀-type ordered structure is shown in FIG. 5 as an FeNi superlattice 40. As shown in FIG. 5, the FeNi ordered alloy having the L1₀-type ordered structure is based on a face-centered cubic lattice, and has a structure in which Fe and Ni are arranged in layers along the (001) direction. Specifically, the FeNi superlattice 40 includes a I site 41 that is the topmost layer in a stacking structure of the (001) plane of the face-centered cubic lattice, and a II site 42 that is an intermediate layer located between the topmost layer and the bottommost layer. In FIG. 5, positions where atoms are arranged at the I site 41 are indicated by white circles, and positions where atoms are arranged at the II site 42 are indicated by black circles. In this crystal structure, an a-axis 43 is in the (010) direction, and a c-axis 44 is in the (001) direction. The c-axis 44 is the easy magnetization axis 35. In the FeNi superlattice 40 with a degree of order of 1, as described later, only Ni atoms are present at the I site 41 among Fe and Ni atoms, and only Fe atoms are present at the II site 42 among Fe and Ni atoms.

The magnetic particles 3 are nanoparticles. That is, the major axis length and the minor axis length are at the submicron level. The major axis length is 1000 nm or less, and more preferably, several hundred nanometers or less. The minor axis length is 100 nm or less, and more preferably, several tens of nanometers or less. “nm” denotes nanometer.

When the magnetic body 2 contains a plurality of magnetic particles 3, it is inferred that not all of these magnetic particles 3 necessarily exist individually, and at least some of the magnetic particles 3 are in a state of being connected to each other. However, even in such a connected state, if there is no fundamental change in the flat shape and the L1₀-type ordered structure of each of the plurality of magnetic particles 3, it is presumed that the properties of the plurality of magnetic particles 3 do not become heterogeneous.

In the present embodiment, the magnetic body 2 is formed such that the degree of order, as measured by powder X-ray diffraction, is higher than 0.7, preferably 0.76 or higher, and more preferably 0.8 or higher. The “degree of order” is an index indicating the extent of ordering in the FeNi superlattice 40, as described in Japanese Patent No. 6528865. When the proportion of metal A present at the I site 41 shown in FIG. 5 is denoted as x, and the proportion of metal B present at the I site 41 is denoted as 1−x, then the proportion of metals A and B at the I site 41 can be expressed as AₓB₁₋ₓ. Similarly, when the proportion of metal B present at the II site 42 is denoted as x and the proportion of metal A present at the II site 42 is denoted as 1−x, the proportion of metals A and B present at the II site 42 can be expressed as A₁₋ₓBₓ. Here, x satisfies a relationship of 0.5≤x≤1. In this case, when the degree of order is denoted as OP, the degree of order is defined as OP=2x−1. The degree of order in the actually manufactured magnetic body 2 is measured by powder X-ray diffraction. The method for measuring the degree of order by powder X-ray diffraction will be described later.

### (Manufacturing Method)

The following is an overview of the method for manufacturing the magnetic body 2 according to the present embodiment. The manufacturing method according to the present embodiment involves first synthesizing FeNiN, which serves as a precursor material for the FeNi ordered alloy, and then performing denitriding treatment on the FeNiN to obtain the magnetic body 2 containing the FeNi ordered alloy. FeNiN has a crystal structure shown in FIG. 6, and can be identified from an XRD diffraction pattern. XRD is an abbreviation for X-ray diffraction. An FeNiN lattice 50 has a I site 51, a II site 52, and a III site 53. The I site 51 corresponds to the I site 41 in the L1₀-type ordered structure. The II site 52 corresponds to the II site 42 in the L1₀-type ordered structure. The III site 53 is located at an intermediate position between adjacent I sites 51 in the stacking direction. In FeNiN 50, it is expected that Ni atoms are present at the I site 51, Fe atoms are present at the II site 52, and N atoms are present at the III site 53.

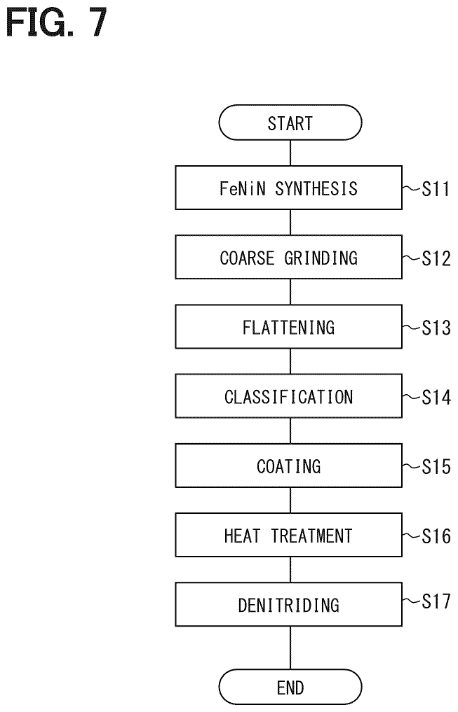

As shown in FIG. 7, the method for manufacturing the magnetic body 2 or the magnetic particles 3 according to the present embodiment is performed by sequentially performing the following steps, processes, or procedures of S11 to S17 in this order.
S11: FeNiN Synthesis—FeNiN, which serves as a precursor material for the FeNi ordered alloy, is synthesized.
S12: Coarse Grinding—The synthesized FeNiN is ground to produce FeNiN particles.
S13: Flattening—Mechanical force, such as mechanical shearing force, is applied to the coarsely ground FeNiN particles to flatten the FeNiN particles.
S14: Classification—The flattened FeNiN particles have a particle size distribution. Therefore, the flattened FeNiN particles with the desired particle size or within the desired particle size range are selected. Hereinafter, in order to avoid complicated notation, the flattened FeNiN particles will be assigned a reference numeral and referred to as “flattened FeNiN particles 61.” The flat surfaces of the flattened FeNiN particle 61, corresponding to the flat surfaces 33 of the magnetic particles 3, will be referred to as the flat surfaces 611. The major axis and minor axis of the flattened FeNiN particles 61, corresponding to the major axis 31 and minor axis 32 of the magnetic particles 3, will be referred to as the major axis 612 and minor axis 613, respectively. The c-axis of the flattened FeNiN particles 61, corresponding to the c-axis 44 of the magnetic particles 3, will be referred to as c-axis 614. The direction or orientation of the c-axis 44 or the c-axis 614 will simply be referred to as the “c-axis direction” or “c-axis orientation.” Meanwhile, FeNiN particles that have not undergone at least the flattening process, as described in Comparative Example 1 below, will be referred to as first comparative example particles 62. In addition, an aggregate of the flattened FeNiN particles 61 or the first comparative example particles 62 will be referred to as a magnetic body precursor 60.
S15: Coating—The surfaces of the selected flattened FeNiN particles 61 are coated with, for example, a constituent material of the coating layer 37 such as silica.
S16: Heat treatment—The flattened FeNiN particles 61 that have undergone the coarse grinding and the flattening process may have defects caused by deformation. In order to repair these defects, heat treatment (annealing) is performed.
S17: Denitriding—Denitriding treatment is performed on the flattened FeNiN particles 61 that have undergone the above processes. Accordingly, the magnetic particles 3 having the flat shape and the magnetic body 2 containing the magnetic particles 3 can be manufactured.

Hereinafter, details regarding each of the processes and Examples will be described.

### (1) FeNiN Synthesis

The synthesis method for FeNiN, which serves as the precursor material, may employ techniques that are already known or well-established at the time of filing the present application. For example, the techniques described in Japanese Patent No. 6528865 and Japanese Patent No. 6627818 can be used. Specifically, for example, FeNiN can be synthesized by nitriding a powder of FeNi amorphous alloy produced by a thermal plasma method, a flame spray method, or a co-precipitation method. Alternatively, for example, FeNiN can also be obtained by reducing and nitriding FeNi oxide. The FeNi oxides used in the reducing process may contain Fe oxide and Ni oxide, or may contain oxide containing Fe and Ni.

The Fe oxide is not particularly limited, and examples of the Fe oxide include FeO, Fe₂O₃, and Fe₃O₄. In addition, oxidized products obtained by oxidizing raw materials such as metallic iron, iron hydroxide, iron carbonate, iron chloride, iron iodide, iron bromide, iron sulfate, iron nitrate, iron phosphate, and iron oxalate can also be used. The Ni oxide is not particularly limited, and examples of the Ni oxide include NiO. In addition, oxidized products obtained by oxidizing raw materials such as metallic nickel, nickel hydroxide, nickel carbonate, nickel chloride, nickel iodide, nickel bromide, nickel sulfate, nickel nitrate, nickel phosphate, and nickel oxalate can also be used. The oxide containing Fe and Ni can be produced by a process including mixing a solution containing Fe and Ni with a precipitating agent to obtain a precipitate containing Fe and Ni (precipitation process), and heat-treating the precipitate to obtain the oxide containing Fe and Ni (oxidation process). According to this method, it is easy to control the average particle size and particle size distribution of the resulting oxide containing Fe and Ni, and the distribution of Fe and Ni within the oxide containing Fe and Ni tends to be uniform.

Fe raw material and Ni raw material are not particularly limited as long as they can be dissolved in acidic solution. Examples of the Fe raw material include metallic iron, iron oxide, iron hydroxide, iron carbonate, iron chloride, iron iodide, iron sulfate, iron nitrate, iron phosphate, and iron oxalate. Examples of the Ni raw material include metallic nickel, nickel oxide, nickel hydroxide, nickel carbonate, nickel chloride, nickel iodide, nickel sulfate, nickel nitrate, nickel phosphate, and nickel oxalate. Examples of the acidic solution include sulfuric acid, nitric acid, hydrochloric acid, and phosphoric acid. A concentration of a solution containing Fe and Ni can be appropriately adjusted within a range where the Fe raw material and the Ni raw material are substantially dissolved in the acidic solution. A reaction between the solution containing Fe and Ni and the precipitant may be carried out by adding the precipitant to the solution containing Fe and Ni, or by adding the solution containing Fe and Ni to the precipitant. In addition, the solution containing Fe and Ni referred to here only needs to contain Fe and Ni at the time of reaction with the precipitant. Fe-containing raw material and Ni-containing raw material may be prepared as separate solutions, and each solution may be added and reacted with the precipitant. Even in cases where they are prepared as separate solutions, adjustments are made as appropriate within the range in which each raw material is substantially dissolved in the acidic solution. The precipitant is not particularly limited as long as it reacts with the solution containing Fe and Ni to yield a precipitate. Examples of the precipitant include oxalic acid, aqueous sodium hydroxide solution, aqueous sodium bicarbonate solution, aqueous potassium hydroxide solution, aqueous lithium hydroxide solution, and other alkaline solutions. In addition, a precipitate can be obtained by introducing carbon dioxide gas into the solution containing Fe and Ni. Examples of the resulting precipitate include oxalates, carbonates, and hydroxides. Specifically, for example, FeNiN can be obtained by subjecting nickel iron oxalate powder to calcination in air, hydrogen reduction, and nitridation.

### (2) Coarse Grinding

As a method for coarse grinding of FeNiN, general grinding methods such as ball milling can be used, for example.

### (3) Flattening

A method for flattening is not particularly limited, and flattening can be easily carried out by using mechanical shearing force. For example, flattening can be carried out by subjecting a slurry containing FeNiN particles to wet bead milling. Specifically, the coarsely ground FeNiN particles are dispersed in a solvent containing a surfactant to prepare the slurry. As the surfactant, a surfactant that exhibits good coating properties with respect to the FeNiN particles can be used. Examples of the surfactant include surfactants containing nitrogen such as oleylamine and trioctylamine, surfactants containing sulfur such as octanethiol and triazinedithiol, and polymeric surfactants such as polyvinyl alcohol, polyacrylic acid, polyethyleneimine, and polyvinylpyrrolidone. As the solvent, a liquid in which the FeNiN particles coated with the surfactant can be stably dispersed may be used. Examples of the solvent include pure water, alcohols such as ethanol and isopropyl alcohol, and non-polar solvents such as toluene and cyclohexane. As Examples, a slurry containing 5 wt % FeNiN particles in ethanol was placed, together with zirconia media with a diameter of 0.1 mm, into a bead mill device (Fritsch planetary ball mill PL-7), and processed at 600 rpm for 30 minutes.

### (4) Classification

In order to obtain high coercivity, small flattened FeNiN particles 61 are extracted. Particle size classification can be performed by centrifuging the slurry. By centrifuging sequentially at 500 G for 10 minutes, 4000 G for 10 minutes, and then 4000 G for 120 minutes, the larger flattened FeNiN particles 61 were precipitated in order, and each precipitate was collected.

### (5) Coating

As described above, the coating layer 37 serves to interrupt the magnetic coupling between the magnetic particles 3 that are located in close proximity within the magnetic body 2. For this reason, the coating layer 37 is formed from a non-magnetic body. In addition, the coating layer 37 needs to be a material that does not react with the alloy particles 36 and is capable of withstanding subsequent heat treatment and denitriding treatment. As materials for the coating layer 37 that satisfy these requirements, for example, oxides of group III to VII or group XIII to XVI elements such as silica, titania, zirconia, yttria, and alumina can be used. In addition, films composed of insulating material such as nitride films may also be employed. The thickness of the insulating film constituting the coating layer 37 may be set optionally, and is preferably 1 nm or more.

In Examples, the classified flattened FeNiN particles 61 were coated with silica (silica coating). By performing the coating at this stage, sintering of the particles due to subsequent heat treatment and denitriding treatment is suppressed. In addition, contact between the alloy particles 36 contained in the magnetic body 2 during molding of the magnet 1 is suppressed. As a result, deterioration of the magnetic properties is suppressed.

When using silica as the coating layer 37, a powder of flattened FeNiN particles 61 is mixed into a solvent of water or ethanol in which tetraethoxysilane has been added, and then an aqueous ammonia solution is further introduced. As a result, the tetraethoxysilane undergoes hydrolysis and condensation to produce silica, which covers the surface of the flattened FeNiN particles 61. The flattened FeNiN particles 61 are coated with the coating layer 37.

### (6) Heat Treatment

The flattened FeNiN particles 61 are subjected to heat treatment (annealing). Accordingly, the atomic arrangement of the flattened FeNiN particles 61 is improved. The flattened FeNiN particles 61, whose atomic arrangement has been improved by this annealing, are then subjected to denitriding treatment. As a result, the degree of order and the coercivity of the FeNi ordered alloy (alloy particles 36) after denitriding are enhanced. The annealing may be performed, for example, in an ammonia gas atmosphere. Specifically, in Examples, the flattened FeNiN particles 61 were placed in an electric furnace into which ammonia gas could be introduced, and heat treatment was performed in the ammonia gas. The ambient temperature can be set in the range of 300 to 450° C., and the treatment time can be set between 4 and 48 hours. The flattened FeNiN particles 61 may contain sulfur as an impurity or additive. While the optimal treatment conditions vary depending on the particle size and the amount of sulfur present in the raw materials, it is preferable to carry out the process at a temperature lower than the nitriding temperature. This is because, after grinding, the stabilizing effect of sulfur on FeNiN is weakened, making it more susceptible to decomposition at high temperatures.

### (7) Denitriding

Denitriding treatment can be performed using the apparatuses and the methods described in Japanese Patent No. 6528865 or Japanese Patent No. 6627818. Specifically, the denitriding treatment can be carried out, for example, by performing heat treatment in a hydrogen atmosphere. The hydrogen flow rate during the denitriding treatment can be set to 0.01 to 10 liters/min per 1 g of flattened FeNiN particles 61, and preferably to 0.1 to 5 liters/min. The heat treatment temperature can be, for example, 100 to 400° C., and preferably 200 to 350° C. The heat treatment time can be, for example, 1 to 24 hours, and preferably 2 to 10 hours.

### Advantageous Effects

Hereinafter, effects achieved by the configuration and the manufacturing method according to the present embodiment will be described with reference to Examples and Comparative Examples.

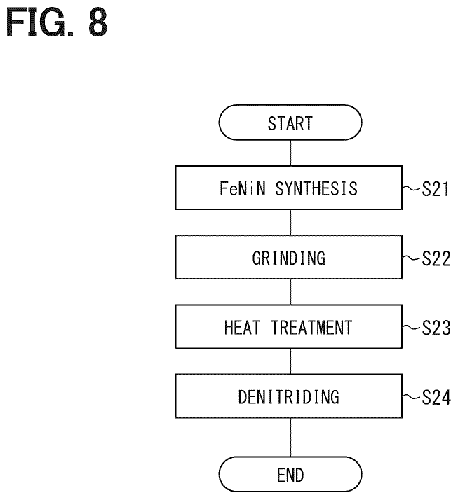

As Comparative Example 1, magnetic particles 3 produced by the manufacturing method shown in FIG. 8 were prepared. In the manufacturing method shown in FIG. 8, the following S21 to S24 are performed.
S21: FeNiN Synthesis—FeNiN, which serves as a precursor material for the FeNi ordered alloy, is synthesized.
S22: Grinding—The synthesized FeNiN is ground to obtain the first comparative example particles 62. The processing conditions are the same as those in S12.
S23: Heat Treatment—Defects may be present in the first comparative example particles 62 that have undergone the grinding process. Therefore, heat treatment (annealing) is performed to repair these defects.
S24: Denitriding—Denitriding treatment is performed on the first comparative example particles 62 obtained as described above. Accordingly, the magnetic body 2 and the magnetic particles 3 as Comparative Example are obtained.

As is clear from the above description, S21 is the same as S11, S22 is the same as S12, S23 is the same as S16, and S24 is the same as S17. The manufacturing method of Comparative Example 1 is obtained by omitting S13 to S15 in the manufacturing method of Examples.

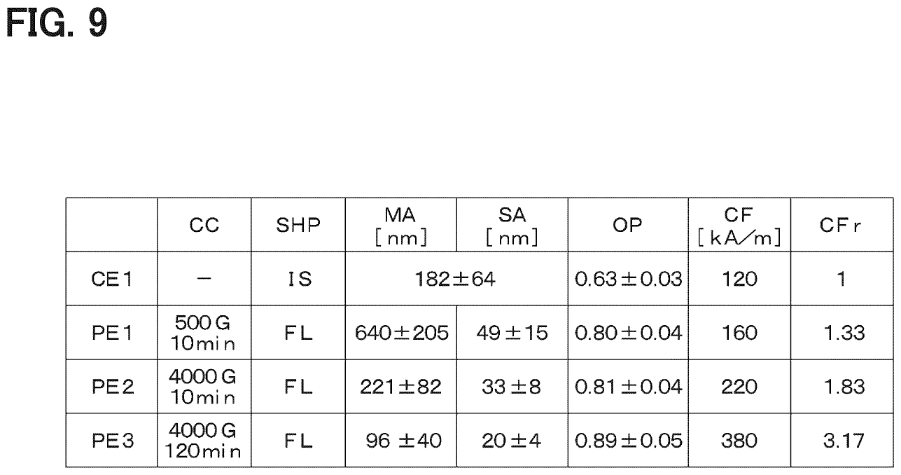

FIG. 9 is a table showing a comparative representation of evaluation results of Comparative Example 1 and Examples 1 to 3. In the table, “CE” denotes “Comparative Example,” and “PE” denotes “Example.” That is, “CE1” denotes “Comparative Example 1,” and “PE1” denotes “Example 1.” “CC” denotes classification conditions, and “SHP” denotes particle shape. In terms of particle shape, “IS” denotes irregular, that is, non-flat shape, while “FL” denotes flat shape. “MA” denotes major axis length, “SA” denotes minor axis length, “CF” denotes coercivity, and “CFr” denotes relative coercivity. These notations are the same in the other drawings as well.

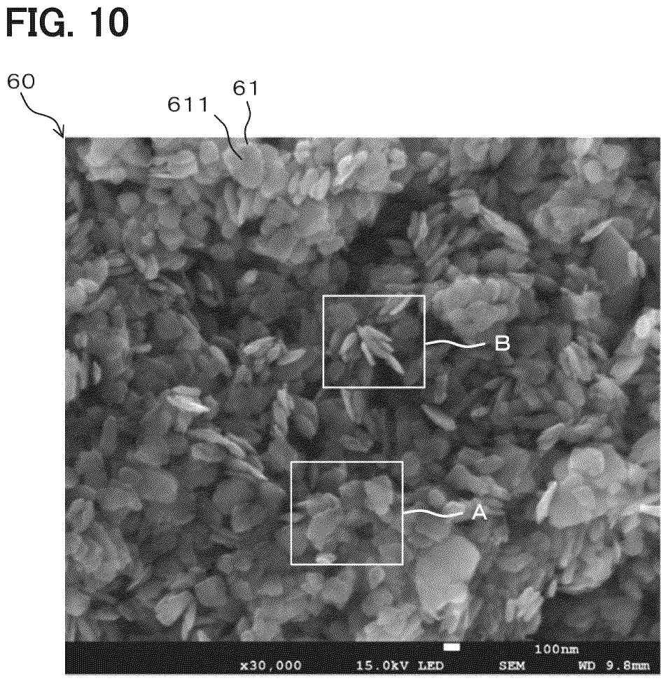

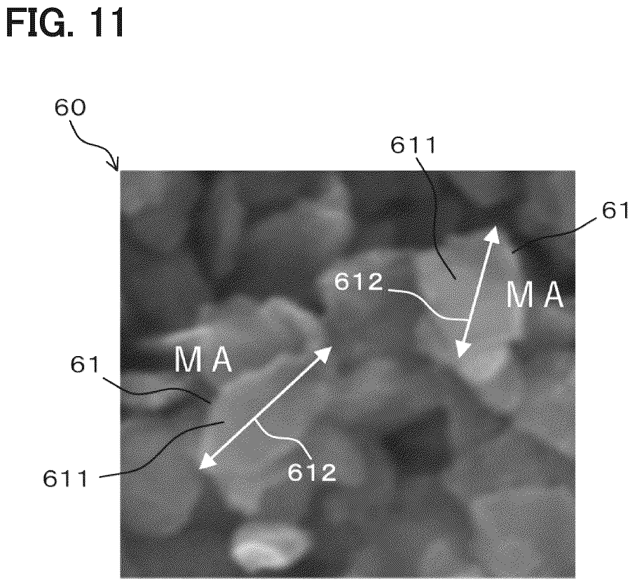

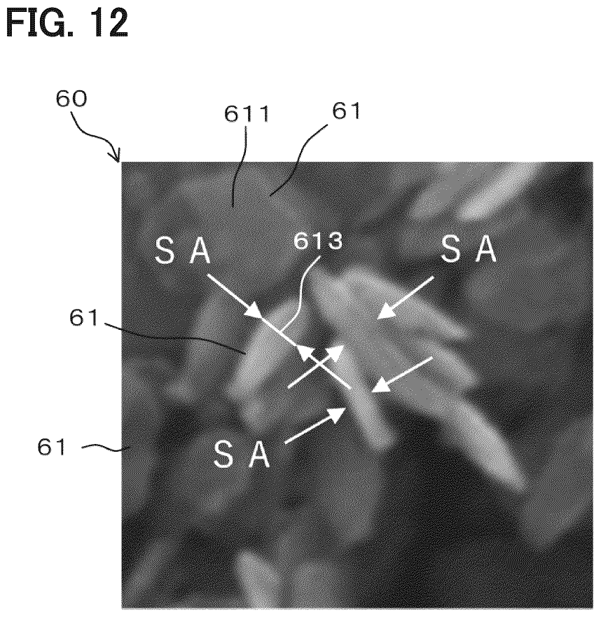

The method for measuring the major axis length and the minor axis length will be explained below with reference to FIGS. 10 to 12. FIG. 10 is an SEM photograph of the magnetic body precursor 60. SEM stands for Scanning Electron Microscope. FIG. 11 is an enlarged view of region A in FIG. 10, and the arrows indicate the major axis length, which is the length of the major axis 612. FIG. 12 is an enlarged view of region B in FIG. 10, and the distances between the pair of opposing arrows indicate the minor axis length, which is the length of the minor axis 613. The major axis length was calculated using image analysis software as described below.

An SEM photograph of Example or Comparative Example to be measured is selected and displayed. As shown in FIG. 11 and FIG. 12, the flattened surfaces 611 of the respective flattened FeNiN particles 61 have varied shapes. Therefore, there are some flattened FeNiN particles 61 for which it is easy to determine the maximum length of the flattened surface 611, and others for which it is difficult. In other words, there are flattened FeNiN particles 61 for which it is easy to determine the major axis length, which is the maximum length along the major axis 612, and others for which it is difficult. The inventors selected, from among the flattened FeNiN particles 61 appearing in the photograph, particles for which it is easy to determine the major axis length, such as particles whose flattened surfaces 611 have an elliptical shape, and did not select particles for which it is difficult to determine the major axis length, such as particles whose flattened surfaces 611 have U-shaped or J-shaped forms. The inventors measured the major axis lengths of the selected flattened FeNiN particles 61.

Specifically, by using image analysis software and drawing a line corresponding to the major axis length on the screen with a straight-line drawing tool, the length of the line segment can be obtained. The length of the drawn line segment can be converted into an actual measurement of the flattened FeNiN particle 61 by calibration using the scale bar shown in the photograph. It should be noted that commercially available image analysis software or free software available as public domain can be used.

In the present embodiment, the average value measured for 100 flattened FeNiN particles 61 is used as the major axis length. Therefore, the major axis length shown in FIG. 9 may also be referred to as the “average major axis length.” It should be noted that, for Comparative Example 1, since the particle shape is nearly spherical, no distinction is made between the major axis length and the minor axis length, and the average particle diameter of 100 particles of the first comparative example particles 62 is used. In addition, since the standard deviation of the measurements for 100 flattened FeNiN particles 61 can be evaluated as the measurement error of the major axis length, this measurement error is indicated in FIG. 9. The same applies to the first comparative example particles 62. Since the measurement error of the major axis length is defined in this manner, variations in measurement error occur between Comparative Example 1 and each of Examples. Specifically, in Example 1, the measured value of the major axis length is 640 nm, and the measurement error (standard deviation) of the major axis length is 205 nm. In contrast, in Example 2, the measured value of the major axis length is 221 nm, and the measurement error of the major axis length is 82 nm.

The minor axis length is measured in the same manner as the major axis length. That is, as shown in FIG. 12, the flattened FeNiN particles 61 in which the minor axis 613 is observed in the photograph are selected, and the thickest portion is measured. Then, the average value measured for 100 flattened FeNiN particles 61 is taken as the minor axis length, and the standard deviation is taken as the measurement error. Since the measurement error of the minor axis length is defined in this way, there are variations in the measurement error between Comparative Example 1 and each of Examples. Specifically, in Example 1, the measured value of the minor axis length is 49 nm, and the measurement error (standard deviation) of the minor axis length is 15 nm. In contrast, in Example 2, the measured value of the minor axis length is 33 nm, and the measurement error of the minor axis length is 8 nm.

It should be noted that, as shown in FIG. 11, in the flattened FeNiN particles 61 in which the major axis 612 can be observed, it becomes difficult to observe the minor axis 613. Conversely, as shown in FIG. 12, in the flattened FeNiN particles 61 in which the minor axis 613 can be observed, it becomes difficult to observe the major axis 612. Therefore, the flattened FeNiN particles 61 for which the major axis 612 was measured and the flattened FeNiN particles 61 for which the minor axis 613 was measured are different particles. The measurement targets for the major axis 612 and the minor axis 613 are different. However, as described above, when measuring the major axis 612 and the minor axis 613, 100 flattened FeNiN particles 61 are selected for each measurement. The average values of the major axis length and the minor axis length are calculated. Therefore, although the measurement targets for the major axis 612 and the minor axis 613 differ as described above, it is expected that the influence of this difference in measurement targets on the calculated major and minor axis lengths is minimal.

As described above, it is not the major axis length and the minor axis length of the magnetic particles 3 after denitriding, but rather the major axis length and the minor axis length of the flattened FeNiN particles 61 before denitriding that are measured. The following describes the reasons. As is clear from the flowchart in FIG. 7 showing the sequence of processes in the manufacturing method, in the present embodiment, the coating process in S15 to form the coating layer 37 is performed before the denitriding treatment in S17. Therefore, in the magnetic particles 3 obtained through denitriding, the outer surfaces of the alloy particles 36 are covered with the coating layer 37. Since the coating layer 37 is electrically insulating, it becomes difficult to capture SEM images due to charge-up. Therefore, it becomes difficult to measure the major axis length and the minor axis length of the magnetic particles 3. For this reason, instead of measuring the major axis length and the minor axis length of the magnetic particles 3, the major axis length and the minor axis lengths of the flattened FeNiN particles 61 are measured.

It is presumed that, due to the denitriding treatment, the size of the magnetic particles 3, in other words, the alloy particles 36, shrinks to some extent compared to the flattened FeNiN particles 61. It is presumed that the change from the FeNiN lattice 50 to the FeNi superlattice 40 results in the lattice constant decreasing by approximately 10%. However, this change in size is within the range of the above-described measurement error (standard deviation). In addition, it is presumed that the particle shape and the size distribution do not change significantly before and after denitriding. As described above, the thickness of the coating layer 37 is about 1 nm, which is also within the range of measurement error. For this reason, the major axis length and the minor axis length obtained from the SEM images of the flattened FeNiN particles 61 are regarded as the major axis length and the minor axis length of the magnetic particles 3.

Additionally, the alloy particles 36 covered with the coating layer 37 can be observed by SEM if gold or the like is sputtered. However, since the thickness of the sputtered layer is added, it becomes difficult to accurately estimate the size. Therefore, this method has not been adopted.

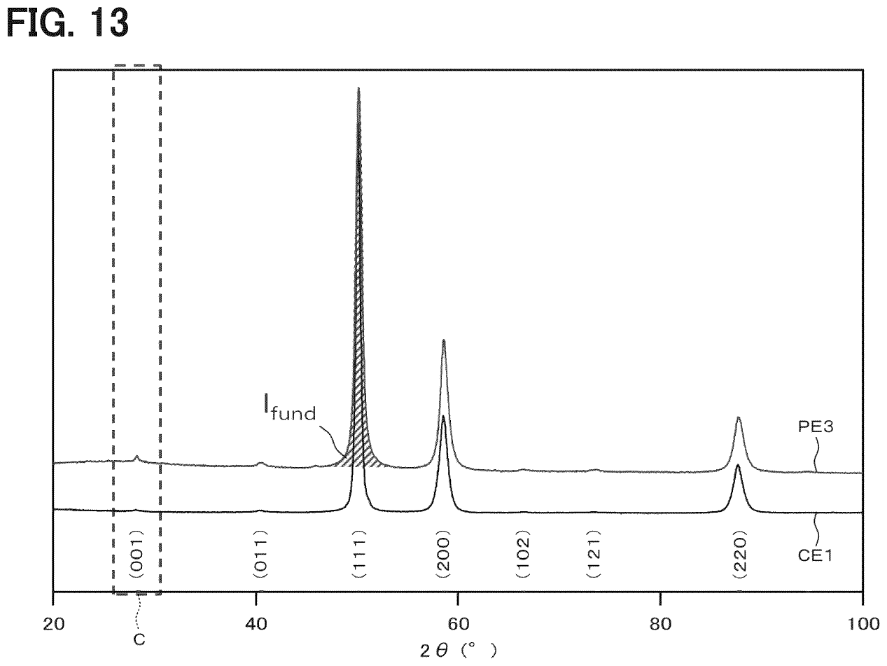

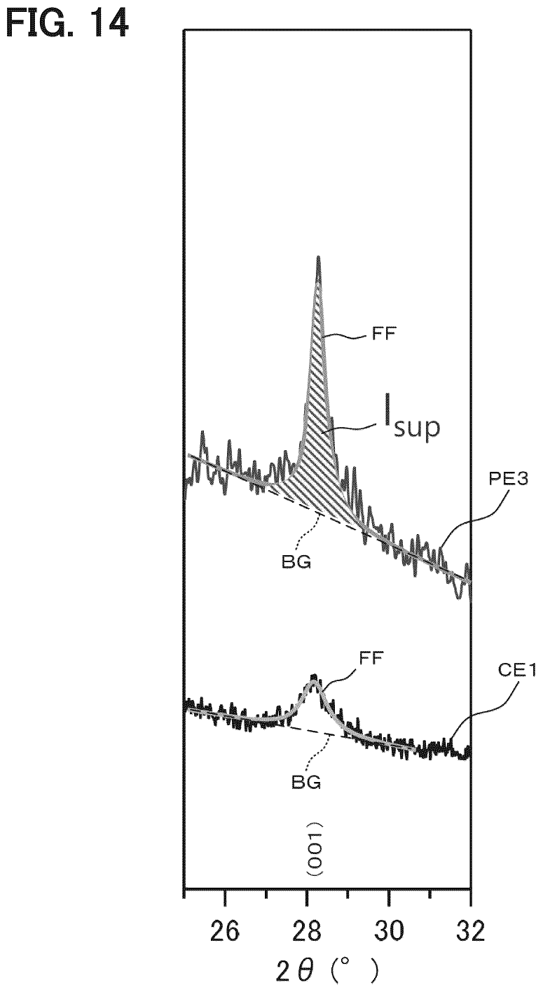

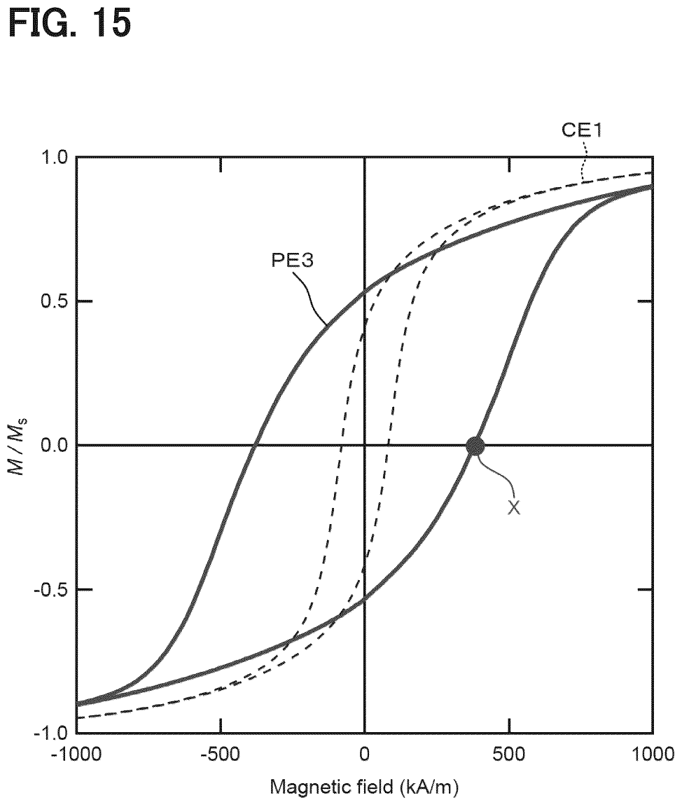

A method for evaluating the degree of order will be explained below with reference to FIG. 13 and FIG. 14. FIG. 13 and FIG. 14 show XRD patterns of Comparative Example 1 and Example 3. In FIG. 13 and FIG. 14, the lower pattern indicated by the reference symbol CE1 corresponds to Comparative Example 1, and the upper pattern indicated by the reference symbol PE3 corresponds to Example 3. FIG. 14 is an enlarged view of region C enclosed by the dashed line in FIG. 13.

The degree of order is calculated using the following formula.

$$OP = \sqrt{\frac{{( {I}_{sup} / {I}_{fund} )}^{obs}}{{( {I}_{sup} / {I}_{fund} )}^{c al}}} \qquad [ Mathematical Formula 1 ]$$

In “(Iₛᵤₚ/I_{fund})^{obs},” “I_{fund}” is, as shown in FIG. 13, the integrated intensity of the fundamental diffraction peak, which is observed in both the FeNi alloy and the L1₀-type ordered FeNi alloy in the XRD patterns. “Iₛᵤₚ” as shown in FIG. 14, is the integrated intensity of the superlattice diffraction peak, which is characteristic diffraction peak of the L1₀-type ordered alloy observed in the XRD pattern. “(Iₛᵤₚ/I_{fund})^{obs}” is the ratio of the integrated intensity of the superlattice diffraction peak to the integrated intensity of the fundamental diffraction peak in the measured X-ray diffraction pattern. On the other hand, “(Iₛᵤₚ/I_{fund})^{cal}” is the ratio of the integrated intensity of the superlattice diffraction peak to the integrated intensity of the fundamental diffraction peak in an FeNi ordered alloy with a degree of order of “1,” as estimated from Rietveld simulation. As for the powder X-ray diffraction apparatus, a general device such as the “SmartLab” manufactured by Rigaku Corporation can be used, for example. By using Fe-Kβ radiation for the X-rays, the degree of order can be determined with high accuracy.

In FIG. 9, measurement errors are also indicated for the measured values of the degree of order. The measurement error is estimated as follows. Due to slight differences in sample setting in the apparatus or analysis conditions, minor variations may occur in the measured values. Specifically, for example, the intensity of the superlattice diffraction lines of FeNi alloy and L1₀-type FeNi ordered alloy is extremely weak, making it susceptible to the effects of noise and background subtraction. The background waveform corresponds to a smoothed waveform of the jagged XRD pattern, excluding the peak region corresponding to Iₛᵤₚ, as indicated by the symbol BG in FIG. 14. Iₛᵤₚ can be estimated by subtracting the BG waveform from an FF waveform that is the entire XRD waveform that has been smoothed. The BG waveform varies, for example, depending on the presence and state of elements other than Fe and Ni. In the XRD pattern, in addition to the pattern of the target sample, components from the substrate, such as non-reflective silicon or silica coating, appear as halos. This halo is fitted with a polynomial using the analysis software accompanying the instrument and removed as background. However, small differences in the fitting parameters can cause variations in Iₛᵤₚ. Therefore, even when measuring the same sample using the Fe-Kβ line, which makes it easier to observe the superlattice diffraction peaks, an intensity error of about 10% can occur. In the present embodiment, the value of the degree of order corresponding to approximately 10% in intensity ratio is regarded as the measurement error. Because the measurement error of the degree of order is defined in this way, there is variation in the measurement error between Comparative Example and each of Examples.

The coercivity is determined as the strength of the magnetic field at which the magnetization direction of the FeNi ordered alloy switches under the influence of the magnetic field, by applying a magnetic field to a sample of the magnetic body 2 obtained. In FIG. 15, the dashed hysteresis curve indicates Comparative Example 1, while the solid hysteresis curve indicates Example 3. A sample formed into a predetermined cylindrical pellet shape is prepared, and a sufficiently strong magnetic field is applied to the sample to bring it to a saturated state in which the magnetization of the sample does not increase any further. Subsequently, a magnetic field is applied in the opposite direction, and the point at which the magnetization of the sample becomes zero is detected. The strength of the magnetic field at that point is defined as the coercivity. In FIG. 15, the point corresponding to the measured value of the coercivity in Example 3 is indicated by the symbol X. The measurement of the coercivity was carried out using a compact cryogen-free physical property measurement system, PPMS VersaLab (PPMS is a registered trademark, VersaLab is a trademark) manufactured by Quantum Design. The magnetic field sweep rate was set to 8 kA/m·sec, the measurement temperature was set to 300 K, and the magnetic field sweep range was set to −2.4 to 2.4 MA/m. The measurement error of the coercivity is at most ±4 [kA/m]. Therefore, the value of the least significant digit in the measured coercivity can be regarded as being within the margin of error. Accordingly, the values of the coercivity shown in FIG. 9 are each written with the least significant digit set to zero, in consideration of this margin of error. The values of relative coercivity shown in FIG. 9 indicate the coercivity, with the coercivity of Comparative Example 1 taken as the reference value of 1.

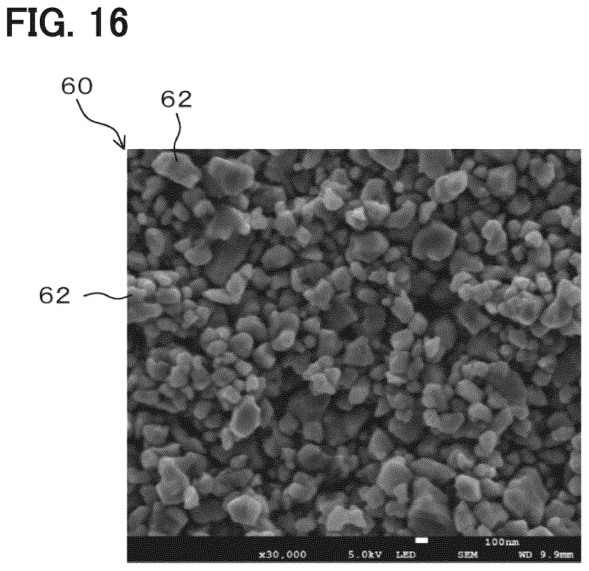

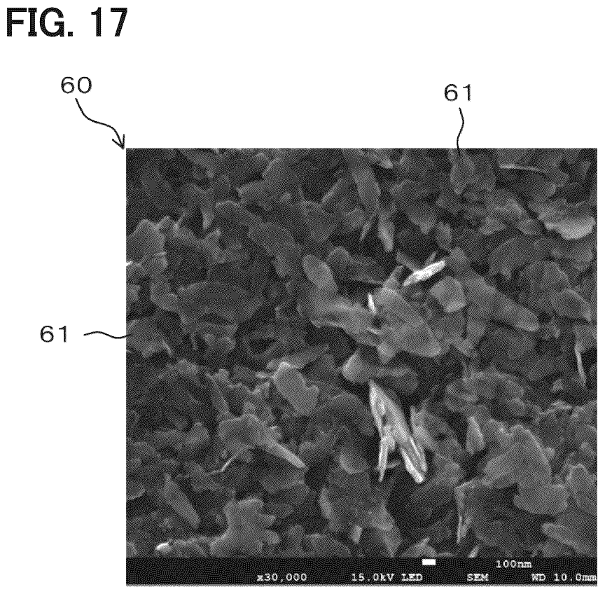

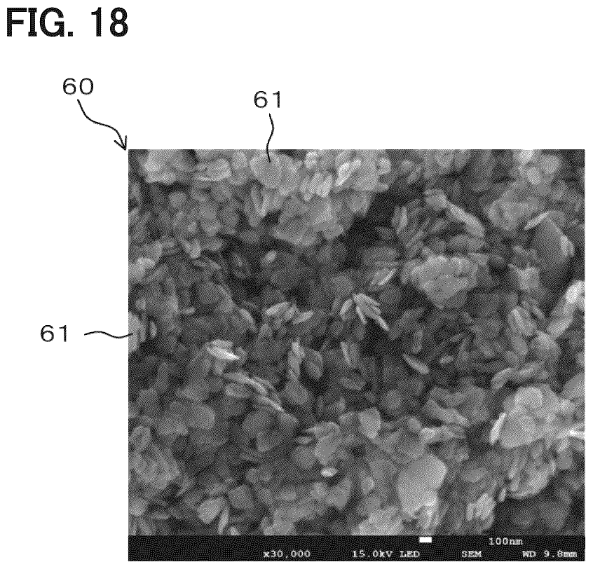

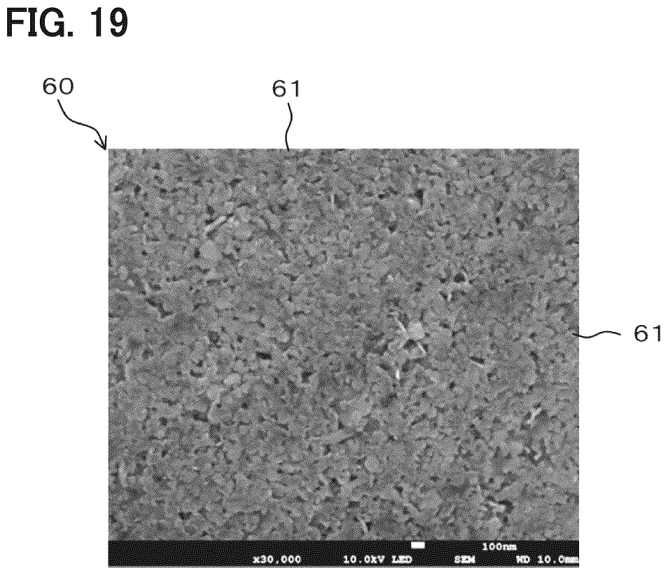

Comparative Example 1 corresponds to a case in which the flattening in S13, the classification in S14, and the coating in S15 of the Examples are omitted. Examples 1 to 3 are cases in which the processing conditions (classification conditions) in the classification in S14 are changed. FIG. 16 shows an SEM image of the magnetic body precursor 60, which is an aggregate of the first comparative example particles 62. FIGS. 17 to 19 show SEM images of the magnetic body precursors 60, which are aggregates of the flattened FeNiN particles 61 in Examples 1 to 3, respectively. As shown in FIG. 16, in Comparative Example 1, the particle shape is not flattened, whereas in Examples, as shown in FIGS. 17 to 19, it was confirmed that the particle shape is flattened. Furthermore, these figures confirmed that the particle size can be controlled according to the classification conditions. That is, it was confirmed that by increasing the centrifugation speed and extending the processing time, smaller-diameter particles can be obtained.

Furthermore, as shown in FIG. 9, it was confirmed that Examples 1 to 3, in which the particle shape was flattened, exhibited improved regularity and higher coercivity compared to Comparative Example 1, in which the particle shape was not flattened. Specifically, in Comparative Example 1, the degree of order could not exceed 0.7. In contrast, in each of Examples, the degree of order exceeds 0.7.

Among Examples, Example 1 has the lowest degree of order, while Example 3 has the highest degree of order. Specifically, Example 1 has a degree of order of 0.80, with a measurement error of 0.04. Example 3 has a degree of order of 0.89, with a measurement error of 0.05. Therefore, in Examples, an expected range of possible values for the degree of order is 0.76 or higher and 0.94 or lower.

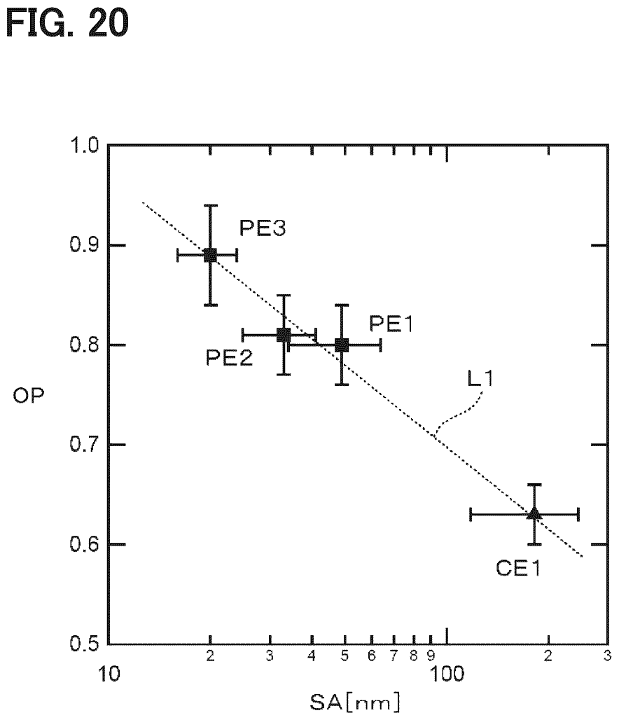

FIG. 20 is a graph showing the relationship between the degree of order and the minor axis length in Comparative Example 1 and Examples 1 to 3. Comparative Example 1 is indicated by a triangular plot, while Examples are indicated by square plots. In addition, error ranges are indicated by error bars.

As shown in FIG. 20, there is a tendency for the degree of order to increase with decreasing minor axis length. Specifically, in the graph using a logarithmic scale of minor axis length shown on the horizontal axis of FIG. 20 and a linear scale with equal intervals of degree of order shown on the vertical axis, there is a negative linear relationship between the minor axis length and the degree of order, in which one decreases as the other increases, as indicated by the dashed straight line L1 in the figure. In particular, by setting the minor axis length to 100 nm or less, or several tens of nanometers or less, it is expected that a degree of order of 0.7 or higher can be achieved. Specifically, for example, it is preferable that the minor axis length be on the order of several tens of nanometers, 50 nm or less, more preferably 30 nm or less, and even more preferably 20 nm or less. As for the possible lower limit of the minor axis length, several nanometers may be considered. As the range of minor axis lengths with a degree of order of 0.76 or higher, several nanometers or more and 50 nm or less may be considered.

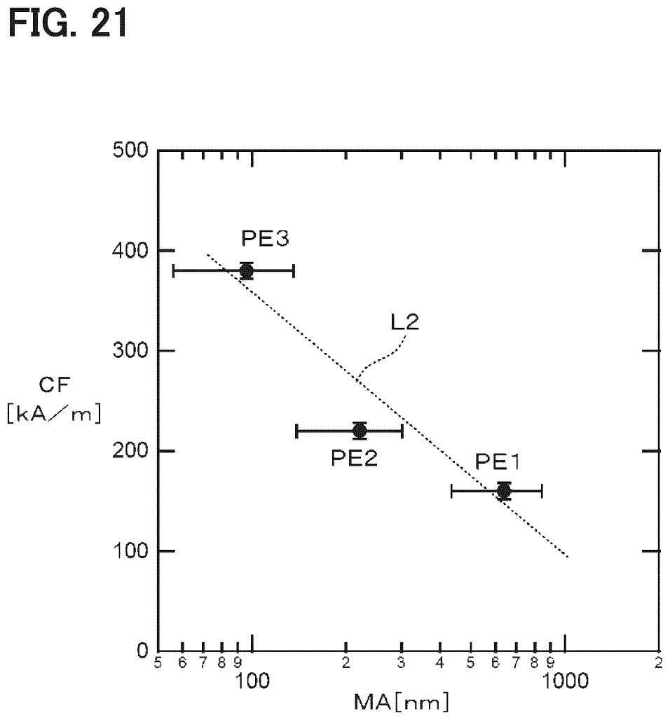

FIG. 21 is a graph showing the relationship between coercivity and major axis length in Examples 1 to 3. Examples are indicated by circular plots. Error ranges are indicated by error bars.

As shown in FIG. 21, there is a tendency for the coercivity to increase with decreasing major axis length. Specifically, in the graph using a logarithmic scale of major axis length shown on the horizontal axis of FIG. 21 and a linear scale with equal intervals of coercivity shown on the vertical axis, there is a negative linear relationship between the major axis length and the coercivity, in which one decreases as the other increases, as indicated by the dashed straight line L2 in the figure. In particular, by setting the major axis length to 1000 nm or less, or several hundred nanometers or less, favorable coercivity can be obtained. Specifically, for example, it is preferable that the major axis length be on the order of several hundred nanometers, 350 nm or less, and more preferably 300 nm or less. As a result, coercivity of 200 kA/m or more can be obtained. As for the possible lower limit of the major axis length, it may be several tens of nanometers or around 10 nm. As the range of major axis lengths that can provide favorable coercivity, several tens of nanometers to 350 nm or less can be considered.

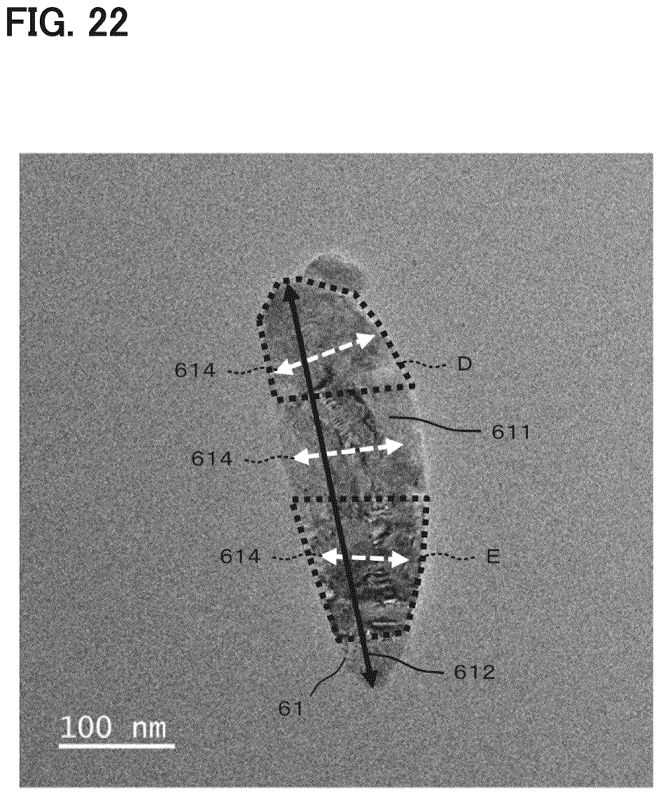

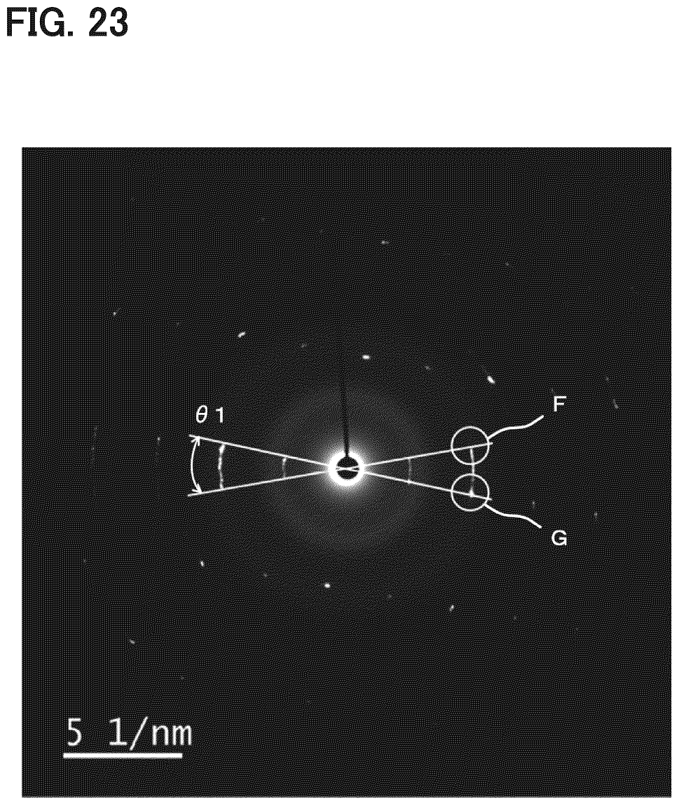

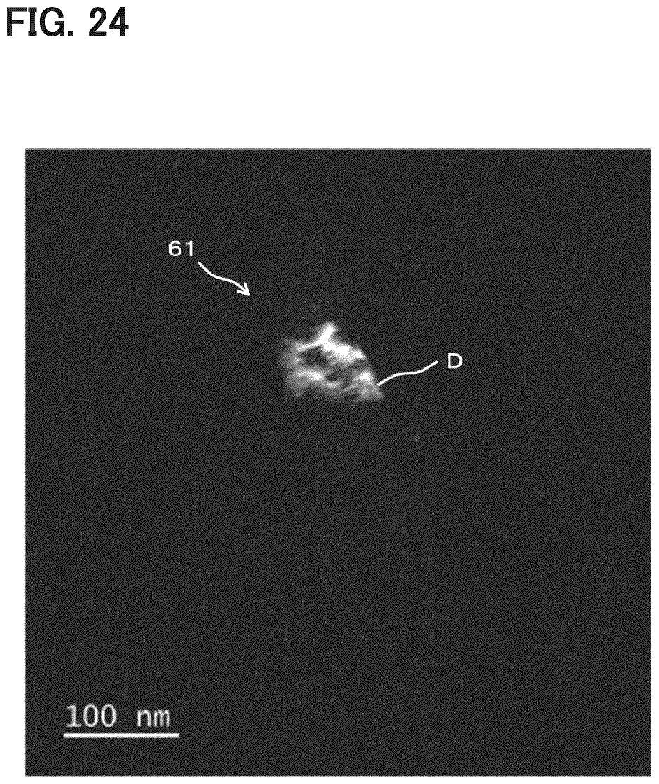

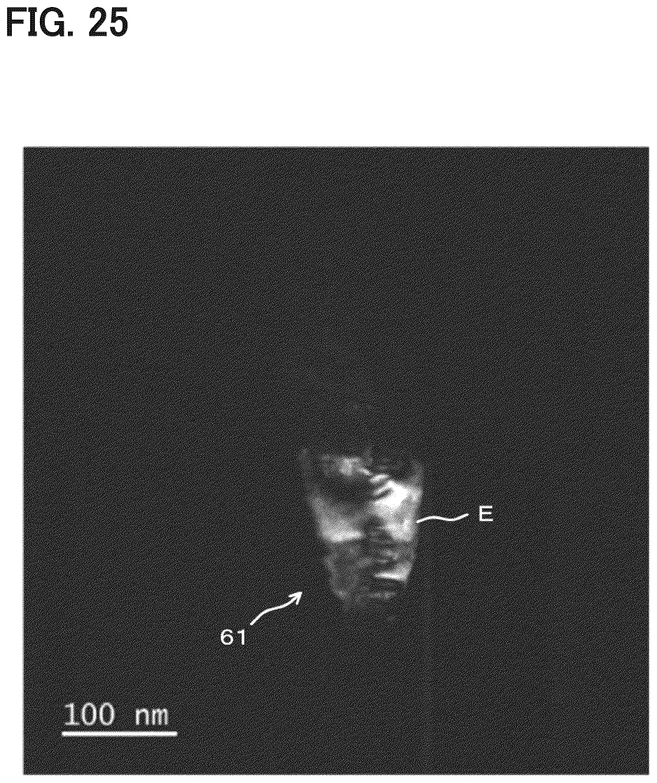

FIG. 22 is a bright-field TEM image of a flattened FeNiN particle 61 in Example 2, having a major axis length of 300 nm or more and an actually measured value of 346 nm. TEM stands for Transmission Electron Microscope. The solid arrow in FIG. 22 indicates the major axis 612. FIG. 23 shows the electron diffraction pattern of this flattened FeNiN particle 61. FIG. 24 is a dark-field image corresponding to the spot enclosed by region F in the diffraction pattern of FIG. 23. FIG. 25 is a dark-field image corresponding to the spot enclosed by region G in the same diffraction pattern. The dark-field image in FIG. 24 corresponds to the region D enclosed by the dashed line at the upper part of the flattened FeNiN particle 61 shown in FIG. 22. The dark-field image in FIG. 25 corresponds to the region E enclosed by the dashed line at the lower part of the flattened FeNiN particle 61.

As described above, when observing the diffraction spots of the flattened FeNiN particle 61 of Example 2 by electron diffraction, diffraction spots indicating that the c-axis 614 is present within the flattened surface 611 were observed. In addition, it was confirmed that the spread of such spots, that is, an angle 61 formed by two white lines in FIG. 23, is approximately 20 degrees. Therefore, as indicated by the dashed arrows in FIG. 22, it was confirmed that, in the flattened FeNiN particle 61 of Example 2, the c-axis directions are present within the flattened surface 611. In addition, it was found that, in the flattened FeNiN particle 61 of Example 2, which has a long major axis as described above, multiple regions with different c-axis directions are arranged along the major axis direction. It should be noted that such orientation of the c-axis 614 is also observed in the FeNi ordered alloy after denitriding.

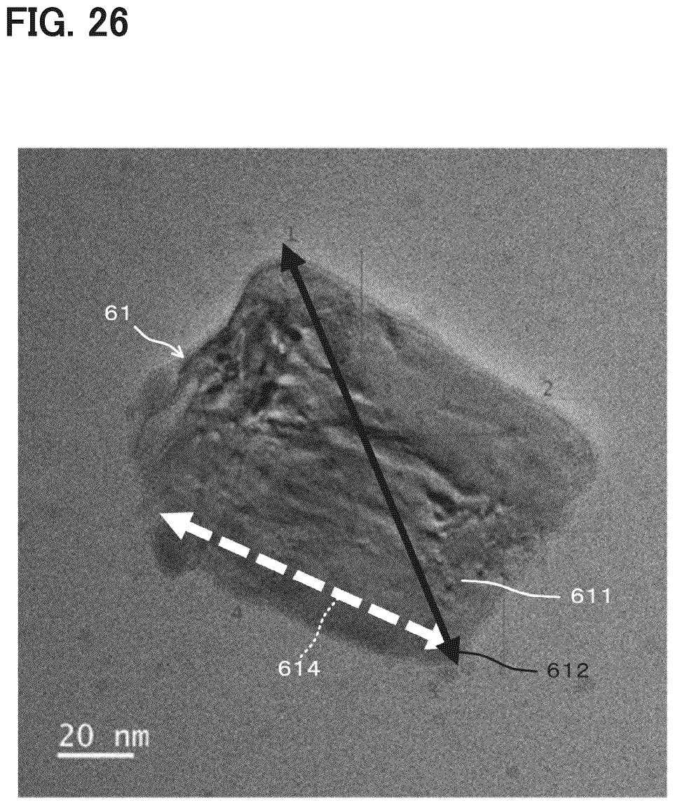

FIG. 26 is a TEM image of a flattened FeNiN particle 61 in Example 3, having a major axis length of approximately 150 nm and an actually measured value of 137 nm. As in FIG. 22, the solid arrow indicates the major axis 612, and the dashed arrow indicates the direction of the c-axis 614. As shown in FIG. 26, it can be confirmed that, in the flattened FeNiN particle 61 of Example 3 as well, the c-axis direction is present within the flattened surface 611.

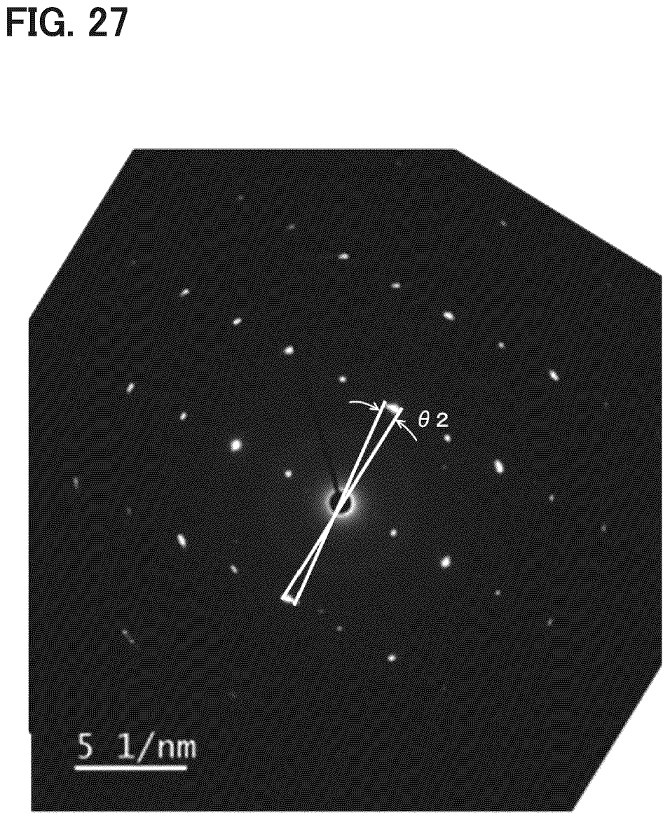

FIG. 27 shows the electron diffraction pattern of this flattened FeNiN particle 61. From FIG. 27, it was confirmed that the spread 62 of the diffraction spots is approximately 5 degrees. In this way, Example 3, which has a shorter major axis length, exhibited a smaller spread of the diffraction spots than Example 2, which has a longer major axis length.

From the above results, it can be inferred that there is a correlation in which the orientation distribution decreases with decreasing major axis length. It is considered that the shorter the major axis length, the narrower the distribution of the c-axis direction, resulting in a higher degree of order and increased coercivity.

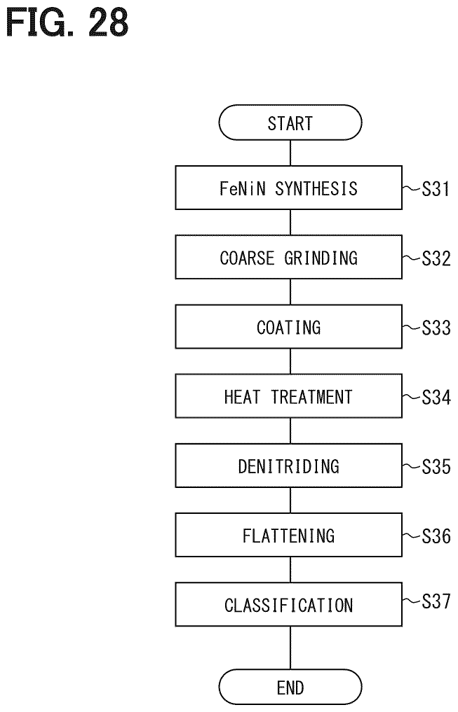

FIG. 28 shows a manufacturing method of Comparative Example 2. Comparative Example 2 was processed in the following order. The FeNiN synthesis was performed in S31, the coarse grinding was performed in S32, and the coating process was performed in S33. Then, heat treatment was performed in S34, denitriding treatment was performed in S35, and flattening was performed in S36. Finally, the classification process was performed in S37. Comparative Example 2 is an example in which the flattening in S13 and the subsequent classification in S14 of Examples were performed after denitriding in S17.

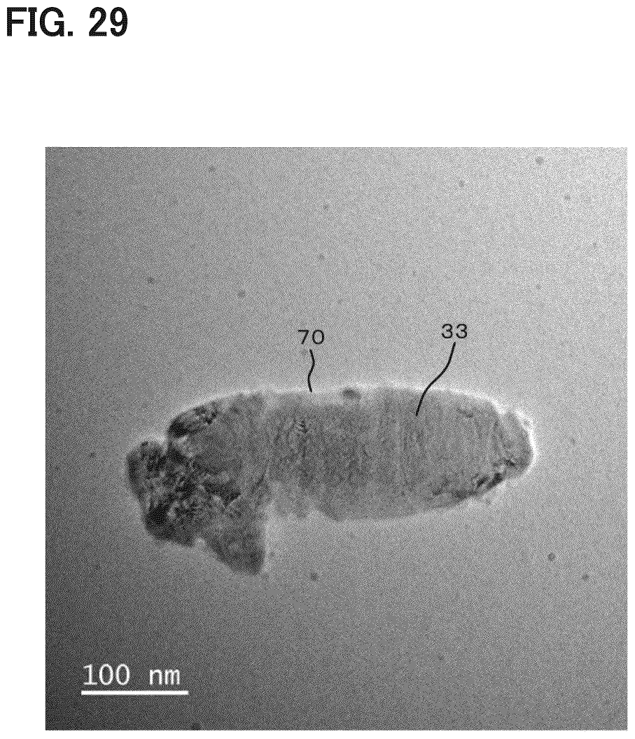

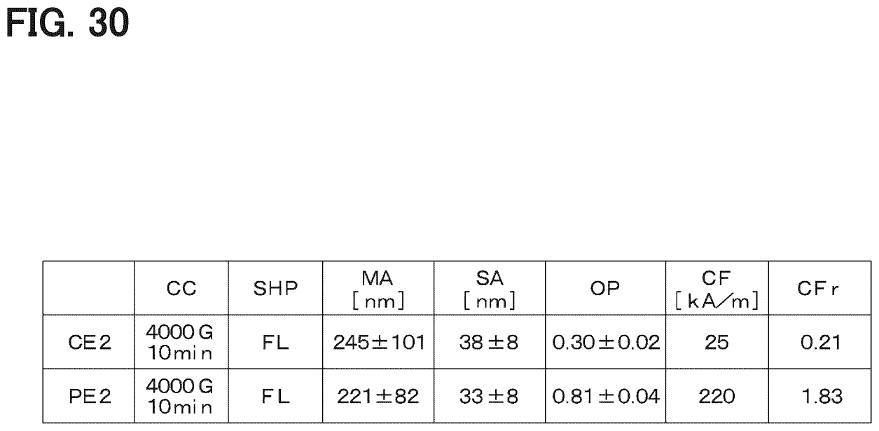

FIG. 29 shows an SEM image of a second comparative example particle 70, which is an FeNi particle in Comparative Example 2. FIG. 30 shows evaluation results of Comparative Example 2 and Example 2 using the same classification conditions. It should be noted that the flattening process is performed after the coating process. Due to this, it is presumed that a portion of the coating on the second comparative example particle 70 has peeled off. Therefore, it is presumed that the image of the second comparative example particle 70 shown in FIG. 29 is less blurred compared to the images of FeNi particles that underwent the flattening process before the coating process.

As shown in FIG. 29, even in Comparative Example 2, the particle shape is flattened. However, as shown in FIG. 30, despite the fact that the particle size and shape are almost the same in Comparative Example 2 and Example 2, a difference was observed in the degree of order and coercivity. That is, in Comparative Example 2, where the flattening was performed after denitriding, although the particle shape was flattened, both the degree of order and the coercivity were reduced and actually became lower than those in Comparative Example 1. In addition, although a diffraction pattern characteristic of polycrystalline particles was observed in the analysis of the electron diffraction image of the second comparative example particle 70, spots corresponding to {001} or {002}, which would appear if the c-axis 44 were present within the flattened surface 33, were not observed. Therefore, it was confirmed that these second comparative example particles 70 are polycrystalline and do not have a specific crystal orientation (that is, non-oriented).

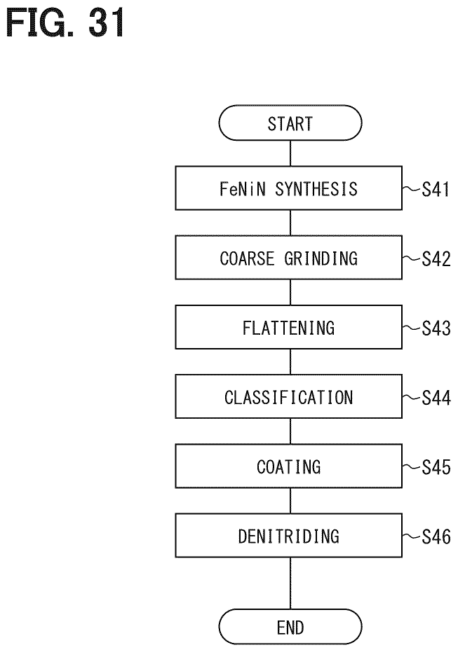

FIG. 31 shows a manufacturing method of Example 4. Example 4 was processed in the following order. The FeNiN synthesis was performed in S41, the coarse grinding was performed in S42, the flattening was performed in S43, the classification process was performed in S44, and the coating process was performed in S45. Then, finally, denitriding treatment was performed in S46. Example 4 is an example in which the heat treatment in S16 in Examples 1 to 3 was omitted.

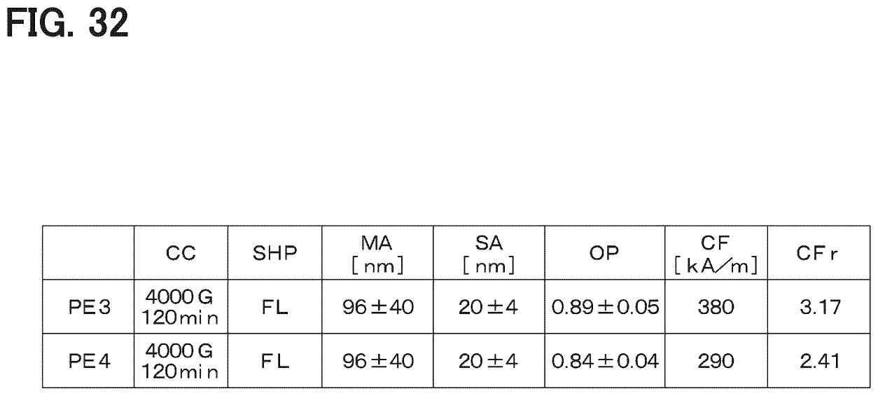

FIG. 32 shows evaluation results of Example 3 and Example 4, in which the classification conditions were the same. As shown in FIG. 32, Example 4 also provides better degree of order and coercivity than Comparative Examples. However, Example 3, in which annealing was performed, exhibited improved degree of order and coercivity. Thus, it can be confirmed that annealing improves the degree of order, which in turn improves coercivity.

In addition, from the comparison between Comparative Example 2 and each of Examples 3 and 4, the following can be inferred. In Comparative Example 2, after the FeNi superlattice is once formed by denitriding, the particles are subjected to mechanical force during the flattening process. It is presumed that this resulted in disruption of the crystal orientation or introduction of defects. In contrast, in Examples 3 and 4, the denitriding treatment was performed on the flattened FeNiN particles 61, whose crystal orientation had been improved by the application of mechanical force during the flattening process. As a result, it is presumed that, as the crystal orientation improves, the reduction in grain boundaries promotes denitriding and increases the degree of order, while a favorable c-axis orientation in the in-plane direction is also achieved. Additionally, it is presumed that, in FeNiN, flattening improves the crystal orientation, whereas in the FeNi superlattice, flattening has no such effect. Furthermore, in Example 3, it is presumed that performing annealing further improved the c-axis orientation and effectively repaired defects.

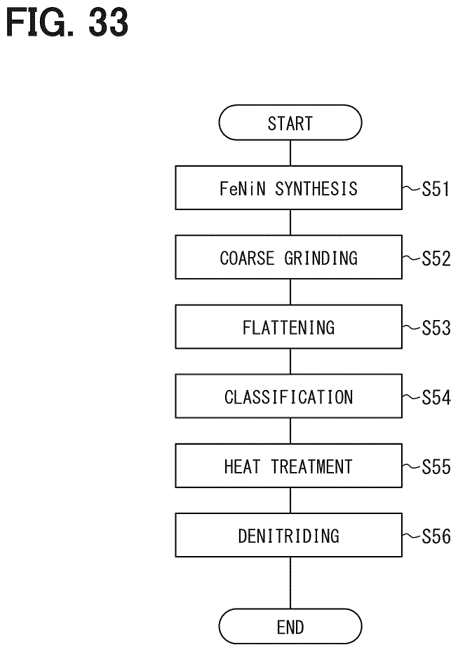

FIG. 33 shows a manufacturing method of Example 5. Example 5 was processed in the following order. The FeNiN synthesis was performed in S51, the coarse grinding was performed in S52, the flattening was performed in S53, the classification process was performed in S54, and the heat treatment was performed in S55. Finally, the denitriding treatment was performed in S56. Example 5 is an example in which the coating in S15 in Examples 1 to 3 was omitted.

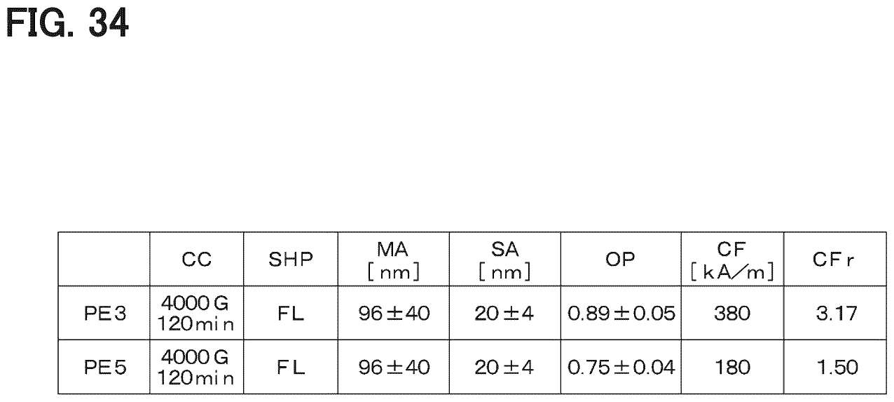

FIG. 34 shows the evaluation results of Example 3 and Example 5, in which the classification conditions were the same. FIG. 35 is a TEM image of the magnetic particles 3 according to Example 3. FIG. 36 is a TEM image of the magnetic particles 3 according to Example 5.

As shown in FIG. 35, in the magnetic body 2 of Example 3, in which coating was performed, it was confirmed that an SiO₂ film constituting the coating layer 37 was present between adjacent alloy particles 36. On the other hand, as shown in FIG. 36, in the magnetic body 2 of Example 5, in which no coating was performed, it was confirmed that adjacent alloy particles 36 were in contact with each other.

As shown in FIG. 34, even in Example 5, a better coercivity was obtained compared to Comparative Examples. In Example 3 as well, the coercivity was improved. The improvement in coercivity in Example 3 is presumed to be because coating the particles before annealing or denitriding suppressed contact and sintering between the particles during annealing or denitriding, thereby maintaining the isolation of the particles. It is also presumed that the high coercivity was achieved because the coating layer 37 produced a magnetic isolation effect between adjacent particles.

As described above, according to the present embodiment or Examples, the magnetic particles 3 individually have the flat shape with the major axis 31 and the minor axis 32, and the easy magnetization axis 35 lies along the flat surface 33 along the major axis 31. With such a structure, in which the easy magnetization axis 35 lies within the flat surface 33, the influence of the demagnetizing field is reduced, making it possible to achieve a higher coercivity.

It is possible to align the direction of the magnetocrystalline anisotropy with the direction of the shape anisotropy, thereby achieving a high squareness ratio. Therefore, superior magnetic properties can be obtained compared to spherical particles.

By adopting a structure in which the magnetic particles 3 are coated with the coating layer 37, it is possible to interrupt the magnetic coupling between particles, thereby enabling an increase in coercivity.

In the case of flat particles, the surface area per unit volume is smaller than that of acicular particles, thereby reducing the required amount of coating material. Therefore, flat particles are more advantageous than acicular particles for increasing the packing fraction of the magnetic material during filling, and it becomes possible to achieve higher density during molding. Therefore, the magnetic flux density and coercivity of the magnet 1 are increased.

The magnetic particles 3 exhibit the above-described properties in their individual state, not being supported by a substrate or other support member. As a result, it becomes easier to mold the magnet 1 using these magnetic particles 3.

According to the present embodiment or Examples, it is possible to provide the magnetic particles 3 with the L1₀-type ordered structure, the magnetic body 2, the magnet 1, and the manufacturing method of the magnetic body 2, all of which exhibit higher coercivity than that of the prior art.

### (Modifications)

The present disclosure is not necessarily limited to the above-described embodiments. The above-described embodiments can be appropriately modified. The following will describe typical modifications. In the following description of modifications, differences from the above-described embodiments will be mainly described. In the following modifications, the same reference symbols as the above-described embodiments are assigned to the same or equivalent parts. Therefore, in the description of the following modifications, regarding components having the same reference symbols as the components of the above-described embodiments, the description in the above-described embodiments can be appropriately incorporated unless there is a technical contradiction or a specific additional description.

There are no particular limitations on the application or shape of the magnet 1. In addition, the application of the magnetic body 2 is not limited to the production of the magnet 1, but can also be applied to magnetic recording media and the like. As described above, any of the individual magnetic particles 3, a powder aggregate of such particles, or a bulk molded body of such powder may be covered by claims based on the present disclosure. The alloy particles 36, which constitute the main component of the magnetic particles 3, may contain elements other than Fe or Ni. Regarding flattening, as long as the particles can be satisfactorily flattened, the method is not limited to flattening using the ball mill or bead mill as in Examples. In addition, the expression “degree of order as measured by powder X-ray diffraction” does not necessarily mean that the degree of order is directly measured by powder X-ray diffraction, rather, it includes degrees of order calculated using various patterns, waveforms, values, and the like, obtained from measurements by powder X-ray diffraction. Therefore, the term “degree of order as measured by powder X-ray diffraction” may also be expressed as “degree of order obtained from measurements by powder X-ray diffraction.”

Needless to say, the elements constituting the above embodiment are not necessarily essential, except in cases such as where it is clearly indicated that the elements are particularly essential, or where it is considered that the elements are obviously essential in principle. In addition, in a case where numerical values, such as the numbers, amounts, and ranges, of constituent elements are mentioned, the present disclosure is not limited to the specific numerical values, except in cases such as where it is clearly indicated that the numerical values are particularly essential, or where the numerical values are obviously limited to the specific numerical values in principle. Similarly, in cases where the shape, the direction, the positional relationship, and the like of the constituent elements are mentioned, the present disclosure is not necessarily limited to the shape, the direction, the positional relationship, and the like unless the shape, the direction, the positional relationship, and the like are indicated as essential or are obviously essential in principle.

What is claimed is:

1. A magnetic body comprising magnetic particles that contain an FeNi ordered alloy having an L1₀-type ordered structure, wherein
the magnetic particles individually have a flat shape in which a major axis and a minor axis shorter than the major axis intersect each other, and a flat surface along the major axis is wider than a side surface along the minor axis, and
an easy magnetization axis of the L1₀-type ordered structure lies along the flat surface.

2. The magnetic body according to claim 1, wherein the major axis has a length of 1000 nanometers or less.

3. The magnetic body according to claim 2, wherein the minor axis has a length of 100 nanometers or less.

4. The magnetic body according to claim 1, wherein a degree of order measured by powder X-ray diffraction is 0.76 or higher.

5. The magnetic body according to claim 1, wherein each of the magnetic particles includes an alloy particle containing the FeNi ordered alloy having the L1₀-type ordered structure, and a coating layer covering a surface of the alloy particle.

6. A magnet comprising a magnetic body including magnetic particles that contain an FeNi ordered alloy having an L1₀-type ordered structure, wherein
the magnetic particles individually have a flat shape in which a major axis and a minor axis shorter than the major axis intersect each other, and a flat surface along the major axis is wider than a side surface along the minor axis, and
an easy magnetization axis of the L1₀-type ordered structure lies along the flat surface.

7. A manufacturing method of a magnetic body including magnetic particles that contain an FeNi ordered alloy having an L1₀-type ordered structure, the manufacturing method comprising:
flattening FeNiN particles; and
performing a denitriding treatment on the FeNiN particles that have been flattened.

8. The manufacturing method of the magnetic body according to claim 7, wherein the denitriding treatment is performed after annealing the FeNiN particles that have been flattened.
